(19) United States
(12) Patent Application Publication
(10) Pub. No.: US 2002/0014573 A1
(43) Pub. Date: Feb. 7, 2002

(54) Machine leveler and method

(76) Inventor: Phillip S. Anderson, Sumerduck, VA (US)

Correspondence Address: BIRCH STEWART KOLASCH & BIRCH, PO BOX 747, FALLS CHURCH, VA, 22040-0747, US

(21) Appl. No.: 09/917,727

(22) Filed: Jul. 31, 2001

Related U.S. Application Data
(60) Provisional application No. 60/222,045, filed on Jul. 31, 2000.

(51) Int. Cl. F16M 1/00

(52) U.S. Cl. 248/677; 248/188.4; 248/188.1

(57) ABSTRACT

A device and method for leveling a machine uses a base with a central opening and a bolt detachably insertable through the opening of the base. The head of the bolt will mate with the opening in this base. A nut can then be screwed onto the bolt in order to lock it to the base. Two additional nuts will hold a machine anchor on the bolt. The nuts adjacent the anchor can be vertically adjusted in order to level the machine. Openings are provided in the base for hold-down screws. These hold-down screws can be drilled through the openings of the base into the floor in order to hold the machine in position in final assembly. Before this time, these screws can be drilled into a pallet, shipping crate or other platform on which the machine is to be transported.

This application claims priority of Provisional Application No. 60/222,045 filed on Jul. 31, 2000, the entire contents of which are hereby incorporated by reference.

### BACKGROUND OF THE INVENTION

1. Field of the Invention

This invention relates to a machine screw leveler and to a method of using the leveler.

2. Description of the Background Art

The process of setting up, leveling, shipping, and final anchoring of machinery has presented some unique problems in the industry. Some systems for leveling a machine have been found to be unsafe or require excessive labor and/or costs.

### SUMMARY OF THE INVENTION

The invention is directed to a machinery leveler which includes a base with a threaded bolt. The head of the bolt will mate with a machined opening in this base. A nut can then be screwed onto the bolt in order to lock it to the base. Two additional nuts can be provided at the opposed end of the bolt. A machine anchor will be placed between these two screws in order to lock it into position. The screws adjacent the anchor can be moved upwardly or downwardly along the length of the bolt in order to change the height of the machine. Openings are provided in the base for hold-down screws. These hold-down screws can be drilled through the openings of the base into the floor in order to hold the machine in position in final assembly. Before this time, these screws can be drilled into the pallet, shipping crate or other platform on which the machine is to be transported. These screws will help hold the machine in position during transport thereby preventing damage or misalignment. Accordingly, basic alignment can be carried out before shipping of the machine and then at the final installation location, only minimal adjustments are necessary. Accordingly, complicated levelers used in the prior art can be avoided. This leveler of the invention provides for a simply and inexpensive solution to existing problems.

It is an object of the present invention to provide an improved apparatus and method for leveling a machine.

It is a further object of the invention to provide a machine leveler which is inexpensive to manufacture and install.

It is yet a further object of the invention to provide a machine leveler which is simple and safe to use.

Still another object of the invention is to provide a machine leveler which requires few parts such that the required inventory of parts can be minimized.

It is another object of the invention to provide a method for leveling a machine which can be quickly carried out and which does not require extensive leveling at the final installation point such that the more complicated and time consuming leveling process can be initially carried out at the initial manufacturing site.

Another object of the invention is to provide a device and method for leveling a machine that can reduce damage to the machine during transport thereof.

These and other objects of the invention are fulfilled by a machine leveler comprising a base having an opening and at least one hole provided therein, a bolt insertable through the opening, holding elements positionable on the bolt, the holding elements receiving an anchor of a machine to be leveled, and at least one fastener for insertion through the at least one hole in the base, the at least one fastener being sequentially mountable in a transportation element and at a final installation location in order to hold the leveler in position.

Moreover, these and other objects of the invention are fulfilled by the machine leveler, comprising a base having an opening, a bolt insertable through the opening, holding elements positionable on the bolt, the holding elements receiving an anchor of a machine to be leveled, and means for sequentially mounting the leveler to a transportation element and then at a final installation, the means for sequentially mounting being affixable on the base.

Additionally, these and other objects are fulfilled by a method for leveling a machine comprising the steps of initially leveling a machine at a first location, the step of leveling using a leveler, placing the machine on a transportation element, temporarily affixing the machine to the transportation element by using the leveler, detaching the machine from the transportation element; and reaffixing the machine at an installation location, the step of reaffixing also using the leveler as recited in claim 1, wherein the fastener is readily accessible when inserted into the at least one hole due to an offset positioning from a location under a machine anchor.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of the machine leveler of the present invention;

FIG. 2 is a side, sectional view of the machine leveler of the present invention;

FIG. 3 is a top, plan view of the base of the present invention;

FIG. 4 is a sectional, side view of the base of FIG. 3 taken along line IV-IV of FIG. 5;

FIG. 5 is a top view of the base of FIG. 3;

FIG. 6 is a top view of the base;

FIG. 7 is a side sectional view of the base and an optional backup plate; and

FIG. 8 is a side view showing the bolt with a portion of an optional washer of the present invention.

### DETAILED DESCRIPTION OF THE PREFERRED EMBODIMENTS

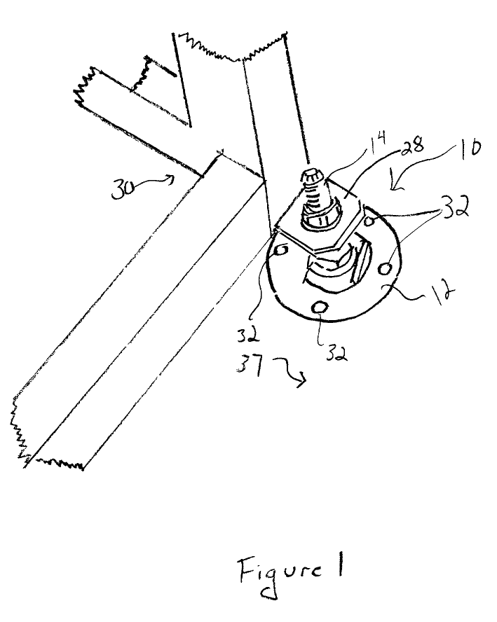

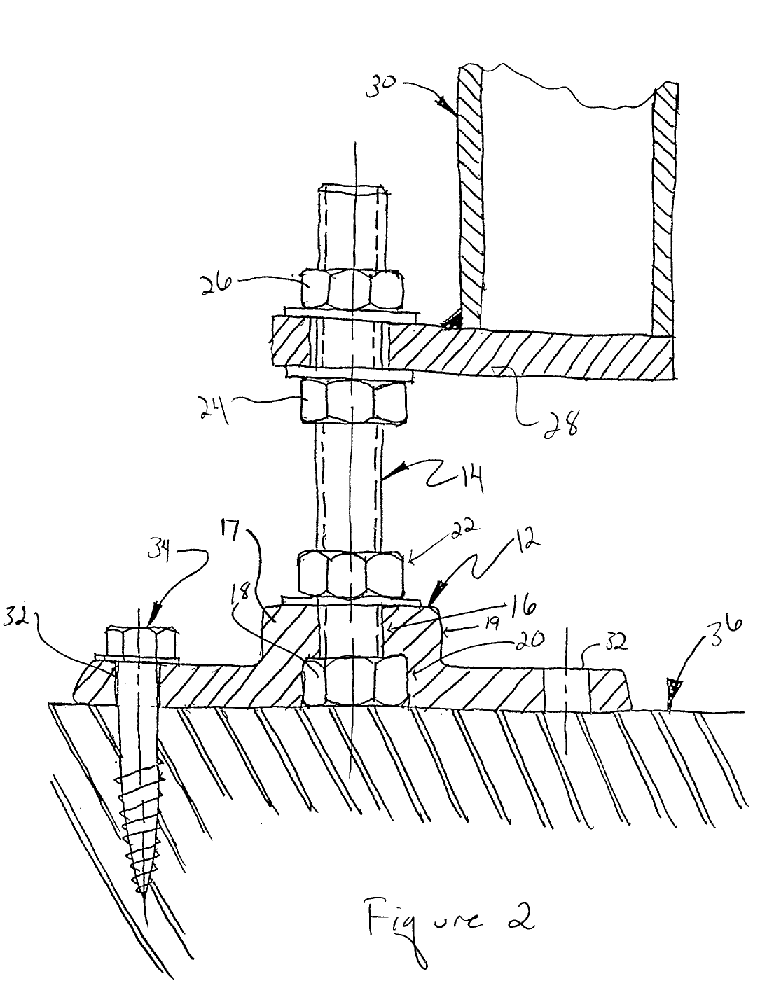

FIG. 1 is a perspective view of the machine leveler 10 of the present invention. This leveler 10 includes a base 12 with a fully threaded bolt 14. The bolt 14 is inserted through an opening 16 in the base 12, as seen in FIG. 2. The opening is provided in a raised portion 17 of the base 12. External wrench flats 19 can be provided around the exterior of the raised portion 17, if so desired. Within the opening 16, a machined interior 20 is provided. This interior can match the shape of the head of the bolt 18. Here, a six-sided or hexagonal shaped head 18 and interior 20 are provided (see FIG. 3, for example). Of course, any suitable shape for the bolt head 18 and interior 20 are possible. These elements do not have to have the same configuration, but the head 18 of bolt 14 should catch or mate with the interior 20 in order to lock these two elements in position. For example, a slot with two sides, which will mate with the head 18 of the bolt, could also be used. It is simply necessary that this interior 20 in the base 12 will lock the bolt in position relative to the base.

A nut 22 will then be screwed onto the bolt 14 in order to lock it to the base 12. Two additional nuts 24, 26 can be used at an upper end of the bolt 14. A machine anchor 28 will be placed between these two nuts 24, 26 in order to lock the machine 30 to the leveler. An assembled arrangement is shown, for example, in FIG. 2. The nuts 24, 26 adjacent the anchor 28 can be screwed upwardly or downwardly in order to change the height of the machine 30, if so desired. Therefore, this machine can be leveled. In the figures, only a portion of the machine frame is shown. It should be appreciated that any type, size or shape of machine 30 or other appliance or device can be leveled using the leveler 10 of the present invention. Also, the upper nut 26 could be replaced with a locking cap or other fastener if so desired.

As seen in FIGS. 1 and 3, the base 12 has four openings 32. One or more of these openings 32 will receive hold-down screws or other fasteners 34 (not shown in FIGS. 1 and 3). These screws, lug bolts or other fasteners 34 act as means for sequentially mounting the leveler to a transportation element 36 or a final installation 37 as will be explained.

As shown in FIG. 2, the hold-down screw or fastener 34 will be drilled or screwed through one or more of the openings 32 in the base 12 into the transportation element 36 or other surface in order to hold the machine 30 in position during transportation. This transportation element 36 can be a pallet, skid, shipping crate or other platform on which the machine is to be transported. These screws or fasteners 34 will hold the machine 30 down during transportation. This will keep the machine 30 from hopping around and becoming damaged or misaligned. When the machine 30 arrives at the final installation location, these screws or fasteners 34 can then be drilled or otherwise affixed to the floor 37 of the final installation or other use location as indicated in FIG. 1. While it is contemplated that the same lug bolts or screws 34 can be used in transportation and final installation, of course, different screws or bolts can be used in transportation and final assembly. Also, lug bolts, screws, anchors, nails, or any other suitable fastener can be used as the fastener 34.

Basic alignment can therefore be carried out in the factory before shipping of the machine 30. At the final installation location, only minimal adjustment to level the machine 30 will be necessary. Therefore, complicated adjustments for leveling of the machine are not necessary after the machine leaves its manufacturing site. This can help reduce possible damage during shipping and can keep manufacturing costs low. Also, it makes the final assembly process safer.

The base 12 can be made from casting and therefore will be a relatively inexpensive part. The base 12 itself might cost $10.00 whereas the bolt 14 might cost $2.00 for a total cost of $12.00.This is considerably less than available prior art machine levelers. The bolt 14 used with the casted base 12 is merely an off-the-shelf bolt. Therefore, it is not necessary to keep a great deal of parts in inventory. Standard bases 12 and a few bolts 14 having different lengths would be all that was necessary to have on hand. Also, it is not necessary to provide for English and metric parts because such size adjustments are not necessary. The base 12 will work with either size bolt 14. If the height of the machine 30 needs to be varied beyond the height of a given bolt, it is simply necessary to insert a longer bolt 14 in the base 12. A great deal of spare parts therefore need not be kept on hand and the overall cost of the system can be kept low.

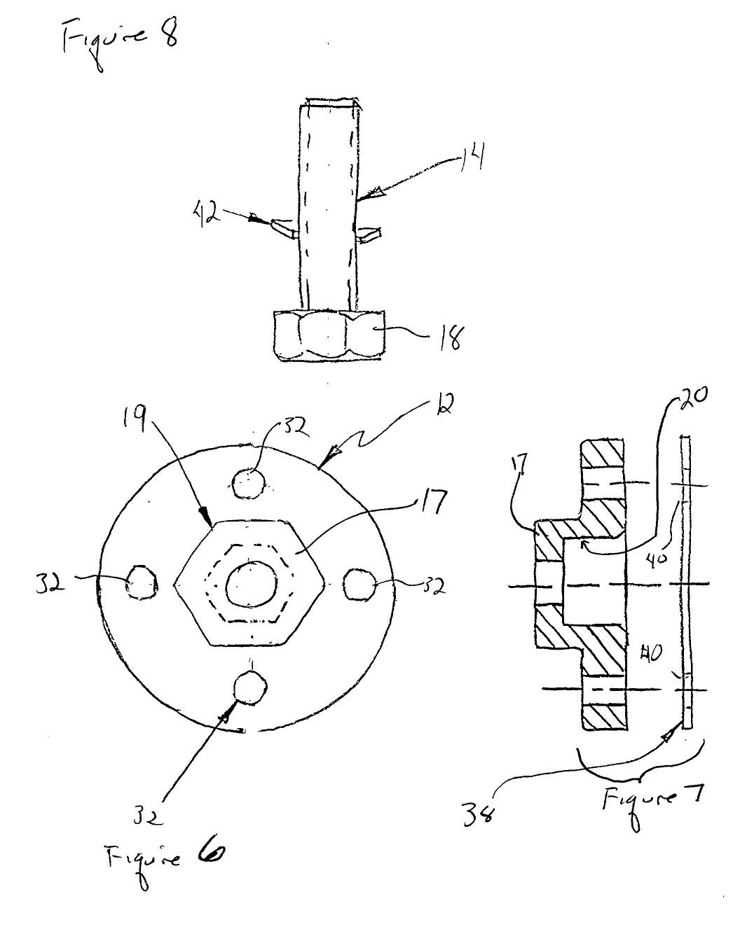

To accommodate vibration, a pad or backup plate 38 can be placed beneath the base 12 as shown in FIG. 7. A steel plate can be used, or a plate made from any suitable material. When the hold-down screw 34 is inserted through the base 12, the screw 34 can be screwed through the pad 38 or openings 40 can be provided in the pad 38 to receive screws 34. The pad 38 shown in FIG. 7 has openings 40 indicated thereon. These openings 40 would correspond to the location of the holes 32 in the base 12. While it is contemplated that the number of openings 40 provided on the pad 38 would correspond to the number of openings 32 on the base 12, such correspondence is not required.

This pad 38 can help dampen vibration. Additional washers 42 can be used if so desired in order to further help dampen vibration and loading impact, as seen in FIG. 8. Only a section of the washer 42 is shown in FIG. 8 and the associated nut 22, 24 or 26 is not shown. A Belleville spring washer can be used, for example. These additional washers can be located adjacent any of the nuts 22, 24, 26 utilized with the system. Also, while only one pad 38 is shown in FIG. 7, it is contemplated that a plurality of pads could be used if so desired. Apart from dampening vibration, the pads 38 can be used as a shim for leveling a portion of the machine, if necessary.

While the prior art also uses ball and socket joints to accommodate different mounting angles, such variation in angles is not normally used. Normally, machines are mounted on relatively flat floors and a high degree of vertical play is unnecessary. Therefore, the use of the pads 38 as a shim is normally not necessary. Moreover, the use of washers 42 in the present invention can allow some minimal vertical play. Additionally, there is some slop between the nuts 22, 24, 26 and bolts 14 and the base 12. Therefore, slight variations in vertical play can be had. If a machine is sent to an installation sight and the floor is not adequately level, it is merely necessary to loosen the bolt 22 adjacent the base 12. Then the base 12 can find its natural home and the bolt 14 can be tightened down. The slop between the bolt 14 and the base 12 can usually accommodate the slope of the floor found at the site of installation.

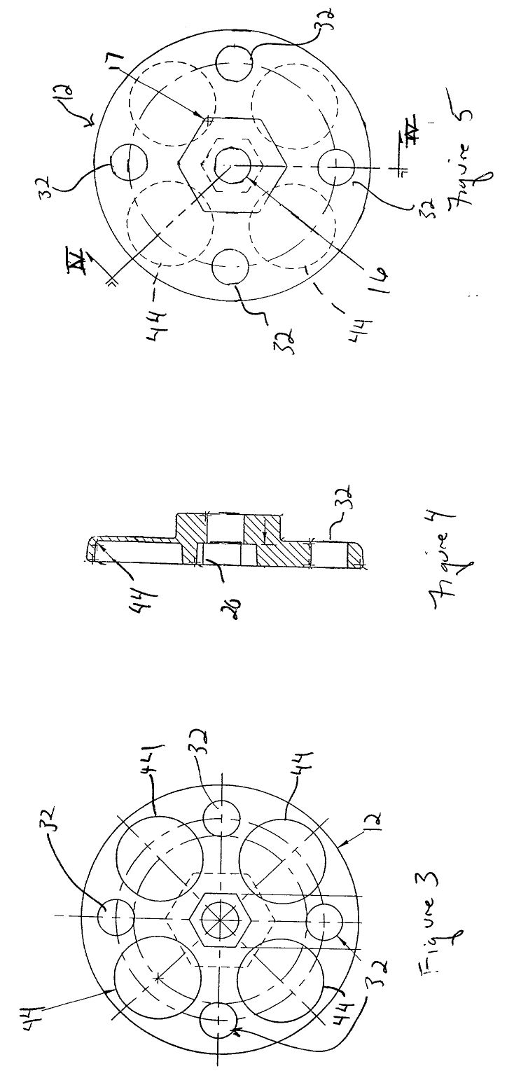

By providing four holes 32 in the base 12 for the hold-down screws, it is relatively easy for the installer to mount the leveler to the floor 36. The four different holes 32 provide at least one hole which is exposed so that installation can be easily carried out. For example, the machine anchor 28 would not cover all four holes 32. While four separate holes 32 are shown on the base 12, any number of holes can be used. Normally one screw 32 would be sufficient and due to the spacing of the holes around the base, this opening can usually easily be accessed. Also, while the openings 32 are equally spaced around the base 12, non-uniform positioning of these openings 32 is also possible. Circular cut-out portions 44 are shown in FIGS. 3-5. These cut-outs simply reduce the amount of material required in making base 12 and do not adversely effect its strength. These cut-outs 44 can be made during molding of the base 12 or by any other suitable method. In fact, the cut-outs 44 can be omitted as indicated in FIG. 6. Alternatively, cut-outs 44, which are non-circular or in other positions on the base 12, can be used. Of course, the number of cut-outs can also be varied as desired.

The present invention provides for a machine screw leveler 10 as well as a method of leveling. This method involves the steps of providing a base 12 and a bolt 14. The bolt 14 is inserted through the central opening 16 in the base and held in position due to the interlocking between the head 18 of the bolt 14 and the base 12. A nut 22 can be then threaded onto the bolt 14 in order to lock the bolt 14 to the base 12. Optional washers 42 between the base 12 and nut 22 can be used if so desired. Thereafter, a second nut 24 will be threaded onto the bolt 14. The machine anchor 28 or other hold down portion of the machinery 30 will then rest on this second screw 24. Any necessary leveling can be carried out in order to make the machine level. Then, a third nut 26 can be screwed onto the bolt 14 in order to hold the machine in place. Finally, a hold-down screw 34 can be drilled through one of the openings in the base in order to mount the entire assembly to the pallet, transportation crate or final installation location 36. This arrangement will prevent the machine 30 from moving during transportation in order to avoid damage to a machine. Moreover, expensive, labor intensive leveling adjustments at final installation need not be carried out since this may be done before initial shipping.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A machine leveler comprising:
a base having an opening and at least one hole provided therein;
a bolt insertable through the opening;
holding elements positionable on the bolt, the holding elements receiving an anchor of a machine to be leveled; and
at least one fastener for insertion through the at least one hole in the base, the at least one fastener being sequentially mountable in a transportation element and at a final installation location in order to hold the leveler in position.

2. The machine leveler as recited in claim 1, wherein the fastener is readily accessible when inserted into the at least one hole due to an offset positioning from a location under a machine anchor.

3. The machine leveler as recited in claim 1, wherein the bolt and the base are readily detachable from one another.

4. The machine leveler as recited in claim 3, wherein the bolt has a head with matingly engages an interior of the opening of the base, the bolt being inserted into the opening through a first side of the base and thereafter extending from an opposed side of the base, the opening in the base extending completely through the base.

5. The machine leveler as recited in claim 4, wherein the bolt and head are a unitary, one-piece element and wherein the shaft of the bolt is threaded.

6. The machine leveler as recited in claim 5, wherein the base is a unitary, on-piece element and wherein the head of the bolt directly engages an interior of the base.

7. The machine leveler as recited in claim 1, wherein the bolt has a head and wherein the head of the bolt directly engages an interior of the base.

8. The machine leveler as recited in claim 1, the holding elements comprise nuts that are screwable on the bolt.

9. The machine leveler as recited in claim 1, further comprising at least one of a pad mountable on an underside of the base and a washer mountable on the bolt.

10. A machine leveler comprising:
a base having an opening;
a bolt insertable through the opening;
holding elements positionable on the bolt, the holding elements receiving an anchor of a machine to be leveled; and
means for sequentially mounting the leveler to a transportation element and then at a final installation, the means for sequentially mounting being affixable on the base.

11. The machine leveler as recited in claim 10, wherein the means for sequentially mounting is a screw which is insertable through at least one hole provided in the base.

12. The machine leveler as recited in claim 11, wherein a plurality of holes are provided in the base and are positioned in an offset location from a machine anchor so that at least one of the holes is readily accessible for the screw.

13. The machine leveler as recited in claim 10, wherein the bolt has a head which mating engages an interior of the opening in the base, the bolt being inserted into the opening through a first side of the base and thereafter extending from an opposed side of the base, the opening in the base extending completely through the base and the bolt being readily detachable from the base.

14. The machine leveler as recited in claim 10, wherein the bolt has a head, the bolt and head being a unitary, one-piece element and the base being a unitary, one-piece element.

15. The machine leveler as recited in claim 10, wherein the holding elements comprise nuts that are screwable on the bolt.

16. The machine leveler as recited in claim 10, further comprising at least one of a pad mountable on an underside of the base and a washer mountable on the bolt.

17. A method for leveling a machine comprising the steps of:
initially leveling a machine at a first location, the step of leveling using a leveler;
placing the machine on a transportation element;
temporarily affixing the machine to the transportation element by using the leveler;
detaching the machine from the transportation element; and
reaffixing the machine at an installation location, the step of reaffixing also using the leveler.

18. The method of claim 17, further comprising the steps of leveling the machine at the installation location after the step of reaffixing, the leveling of the machine at the installation location being less of a leveling than initially done at the first location.

19. The method of claim 17, further comprising the step of transporting the machine and the leveler when the machine is affixed to the transportation element.

20. The method of claim 17, wherein the leveler includes a base with an opening and a bolt extending through the opening of the base, the leveler also includes holding elements longitudinally adjustable along a length of the bolt, the step of initially leveling comprising the steps of:
placing a first holding element on the bolt;
placing an anchor of the machine on the first holding element;
adjusting a position of the first holding element along the length of the bolt to thereby level the machine; and
placing a second fastening device on the bolt, the anchor of the machine being between the first and second holding elements.

21. The method of claim 20, wherein the base includes at least one hole and wherein the leveler further comprises at least one fastener,
the step of temporarily affixing comprises the step of inserting the at least one fastener through one of the at least one holes in the base and into the transportation element in order to detachably mount the leveler and machine to the transportation element, and
the step of detaching the machine comprises the step of removing the at least one fastener from the transportation element.

22. The method of claim 21, wherein the step of reaffixing comprises the step of inserting one of a same at least one fastener or a new fastener through one of the at least one holes in the base and into the installation location in order to mount the machine at the installation location.
